(19) United States
(12) Patent Application Publication
(10) Pub. No.: US 2023/0096771 A1
(43) Pub. Date: Mar. 30, 2023

(54) Aerosol Generation Device Providing Enhanced Vaping Experience

(71) Applicant: JT International SA, Genève (CH)

(72) Inventor: Eduardo Jose Garcia Garcia, Grand-Saconnex (CH)

(73) Assignee: JT International SA, Genève (CH)

(21) Appl. No.: 17/909,034

(22) PCT Filed: Feb. 22, 2021
(86) PCT No.: PCT/EP2021/054350

§ 371 Date: Sep. 2, 2022

(30) Foreign Application Priority Data
Mar. 5, 2020 (EP) 20161309.8

(51) Int. Cl. A24F 40/57; A24F 40/20; A24F 40/53; A24F 40/60

(52) U.S. Cl. CPC A24F 40/57; A24F 40/20; A24F 40/53; A24F 40/60; A24F 40/46

(57) ABSTRACT

The invention relates to an aerosol generation device including a heating element arranged for heating an aerosol substrate such as a tobacco stick; an energy supply configured to power said heating element; a temperature sensor configured to measure the temperature of the heating element; a controller configured to control, as soon as said aerosol generation device is turned on, power supplied from said energy supply to the heating element to heat up the heating element to a first temperature comprised within an operational temperature range
wherein power can only be supplied to the heating element at an activation time of said aerosol device when said aerosol device is turned on, if the temperature of the heating element is lower than a predetermined activation temperature.

### TECHNICAL FIELD

The invention relates to the field of heated aerosol generation devices.

### BACKGROUND

Aerosol generation devices fitted with aerosol substrates for vaping, also commonly known as heat-not-burn electronic cigarettes, are nowadays increasingly used as a substitution for regular cigarettes. However, unlike for regular cigarettes, it is difficult to provide consistent vaping properties over vaping cycles of the aerosol substrates, often in form of sticks.

Solutions aimed at controlling heating process to generate aerosol throughout a vaping cycle are known. Patent document EP2879533 for example discloses an aerosol generation device showing a temperature scheme having three power control phases: a first power ramp-up phase for reaching a vaping temperature for the first puff, a second power decreasing phase for the next puffs, and a final power increasing phase for compensating for the aerosol depletion in the substrate. However, nothing is foreseen to control power between successive vaping cycles, and in particular, between two consecutive vaping cycles.

Yet when vaping two sticks consecutively, e.g. in less than a few seconds, the heater may have no time to cool down sufficiently and a lot of energy remains stored in the heating chamber. As a result, when the heater is switched on again to heat inserted aerosol substrate, the temperature during the first puff may exceed the one expected by the user or the one in normal operation (when heater is sufficiently cooled down), and in turn be perceived as too high or causing too much heat transferred to the aerosol substrate affecting taste of generated vapor. This problem may be amplified by the high moisture content of the substrate which creates a lot of vapor at the time of the first puff.

There is hence a need for a new aerosol device able to overcome these known limitations.

Patent document WO2018027189 relates otherwise to a vaping device using cartridges which is fitted with an anemometer in order to detect puffing activity, and interacts with a heating control mechanism to adjust the heating level whenever needed, and in particular when puffing activity is detected, which triggers a heating phase until a predetermined vaping temperature is reached. However, nothing is foreseen in the disclosed vaping device to prevent heating whenever a temperature should be too high at activation time.

Patent document US2017135407 describes another cartridge-based vaping device fitted with another self-activation mechanism to adjust temperature, yet still not providing any mechanism for preventing heating at activation time if the temperature should be to too high at this moment in time.

Patent document EP2609820 discloses another aerosol device, using tobacco sticks as substrates, and that is aimed at preventing activation of the heater when no substrate or an inadequate substrate is present; this is achieved through the measurement of energy thresholds. Such a solution does not relate to the consistency between vaping cycles at all, though.

### SUMMARY

The present invention is aimed at offering a new aerosol generation device ensuring consistent user vaping experience not only during single vaping cycles with longer time intervals between vaping cycles, but continuously over repeated vaping cycles with shorter time intervals between vaping cycles.

To this end, the present invention concerns an aerosol generation device comprising:
a heating element arranged for heating an aerosol substrate;
an energy supply configured to power said heating element;
a temperature sensor configured to measure the temperature of said heating element;
a controller configured to control, as soon as said aerosol generation device is turned on, power supplied from the energy supply to the heating element to heat up the heating element to a first temperature comprised within an operational temperature range,
wherein power can only be supplied to the heating element at an activation time of the aerosol device, when the aerosol device is turned on, if the temperature of the heating element is lower than a predetermined activation temperature.

An advantage conferred by the claimed solution is that it is possible to control the energy delivered by the heating element to the aerosol substrate, e.g. a tobacco stick, in a way ensuring that the temperature of the first puff does not exceed a desirable value when starting vaping. As a result, consistent vaping experience is maintained throughout consecutive vaping cycles.

According to the invention, the activation time is the time when the aerosol device is turned on upon user's request in order to start a vaping cycle, and power is prevented from being supplied to the heating element, at this activation time, as long as the temperature of the heating element is above the predetermined activation temperature threshold.

As a result, any activation of the heating element is prohibited when a predetermined temperature threshold is exceeded, which ensures most consistent vaping experience throughout consecutive vaping cycles. Indeed, the user, when he wants to start any vaping cycle, is then not able to activate the heating element as long as the temperature thereof is not sufficiently low, i.e. until it has cooled down enough to reach levels below this predetermined temperature threshold again.

According to a preferred embodiment for the present invention, the aerosol substrate is a tobacco stick.

This way, the provided aerosol device is compliant with any popular T-vapor device, whereby the solid tobacco stick emulates a real cigarette and therefore remains as close as possible a regular smoking experience, while getting rid of the known disadvantages of it.

According to a preferred embodiment for the invention, a temperature control scheme of the controller is adjusted so that the temperature of the heating element at the end of a vaping cycle is below the predetermined activation temperature.

An advantage of this embodiment is that it can provide seamless user experience between two consecutive vaping cycles, which can start one right after the other.

According to a further preferred embodiment for the invention, the vaping cycle includes a final heat-off phase during which power is switched off to the heating element for a predetermined time period.

An advantage of this embodiment is that it allows, thanks to the final heating off phase foreseen in the vaping cycle itself, to already cool down the heating element so that it can be switched on again immediately right after the user has just been notified of the end of a vaping cycle without significantly affecting the user's vaping experience during the next one. The duration of this heat-off phase may preferably be possibly adjusted depending on the exact temperature of the heating element inside the operational temperature range at the time when it is switched off.

According to a preferred embodiment for the invention, the predetermined activation temperature is set to be at most equal to 170° C.

This temperature value has been found to optimize the user experience's consistency without needing to generate a too long interruption time between the end of a given vaping cycle of a stick, and the time when a next stick is ready to vape.

According to a preferred embodiment for the invention, the controller is configured to further delay power supply to the heating element after activation time until another predetermined temperature threshold, set below said activation temperature, is reached by the heating element.

An advantage of this embodiment is that it further optimizes the user experience's consistency as far as first puff experience during a vaping cycle is concerned.

According to another preferred embodiment for the invention, the controller is configured to generate a low power supply mode at activation time as soon as the aerosol generation device is turned on if a temperature below the activation temperature is detected for the heating element.

An advantage of this embodiment is that it allows to optimize the batteries lifetime, i.e. the overall number of cycles that may be available before a needing to recharge the aerosol generation device.

According to a preferred embodiment for the invention, the aerosol generation device comprises an active user interface for receiving user input to turn the aerosol generation device on.

The provision of such a user interface allows to interact easily with the user in order to trigger the beginning of a vaping cycle through any suitable actuator, or sensors detecting tapping, shocking of sliding on a surface (such as e.g. a tactile screen). According to yet a further preferred embodiment for the present invention, this active user interface is realized through a push button provided on a side surface of the aerosol generation device, hence allowing for easy manipulation and click effect as a feedback for activation.

According to a preferred embodiment for the invention, the aerosol generation device further comprises a passive user interface arranged for providing indication on mode or status of said aerosol generation device. Such a passive user interface can thus provide efficient user feedback not only during the whole vaping cycle, but also between vaping cycles or even during charging time of the aerosol device. According to yet another preferred embodiment, this passive user interface is preferably configured as a central LED display, in order to provide a most efficient and intuitive instantaneous user feedback.

According to a preferred embodiment for the invention, the aerosol generation device further comprises a vibrator arranged to provide feedback on state transitions of the aerosol generation device. This tactile feedback can advantageously be combined with a distinct visual feedback apparatus provided otherwise, e.g. through LED display, in order to hint at key events or changes happening during a vaping cycle and that may affect the behavior of the user directly and immediately (i.e. by knowing that vaping is available or no more available).

According to a preferred embodiment for the invention, the aerosol generation device further comprises a slider arranged to cover the heating element in a first position, and to leave space for insertion of the aerosol substrate in a second position, wherein the aerosol generation device can only be turned on in the second position of the slider.

This way, the slider acts as a general switch for the aerosol generation device which can then only be switched on when a stick is likely to be introduced into the heating device. Once the aerosol generation device is switched on, it can remain in a sleep mode where the heating element is still not available, and can only be activated only as soon as the aerosol generation device is turned on through another active user interface, such as a press button. This way, additional security is ensured against overheating of the device.

According to a preferred embodiment for the invention for the aerosol generation device, power is supplied to the heating element until it reaches a first temperature so that the amount of energy provided to the aerosol substrate remains within a predetermined range irrespective of the temperature of the heating element at activation time.

An advantage of this preferred embodiment is that is further optimizes the user experience's consistency, especially as far as the temperature of the first puff is concerned, irrespective of the temperature of the heating element at the start of a vaping cycle at activation time, i.e. whether this cycle is started at room temperature, of whether a consecutive vaping cycle is started immediately after a previous one, whereby the temperature would be much higher. This way, it is ensured that the temperature of the first puff remains substantially identical for any vaping cycle, and also independently from any initial conditions.

Further advantageous features aimed at optimizing power regulation and efficiency of the newly provided aerosol generation device are discussed hereafter in the detailed description, further in view of the drawings illustrating preferred embodiments for the present invention.

### BRIEF DESCRIPTION OF THE DRAWINGS

The invention will now be described in greater detail with reference to accompanying figures, in which:

FIG. 1 is made of FIGS. 1A and 1B showing respectively a side perspective view of a preferred embodiment of an aerosol generation device according to the present invention comprising a slider in a first position, where no stick can be inserted, and in a second position, where a stick is inserted.

FIG. 2 shows a schematic logical view of an aerosol device according to a preferred embodiment for the present invention.

FIG. 3 shows a diagram representing the temperature of the heating element with respect to the elapsed time during a vaping cycle according to a preferred embodiment for the present invention.

FIG. 4 shows a diagram representing the temperature of the heating element with respect to the elapsed time during two consecutive vaping cycles according to a preferred embodiment for the present invention.

FIG. 5 shows a diagram representing superimposed curves of temperature of the heating element with respect to the elapsed time during two consecutive vaping cycles according to an alternative embodiment for the present invention.

### DETAILED DESCRIPTION

In the following, an aerosol generation device 1 according to a preferred embodiment will be described, as well as a preferred temperature control scheme using such a device in order to ensure that the heating element of this can cool down.

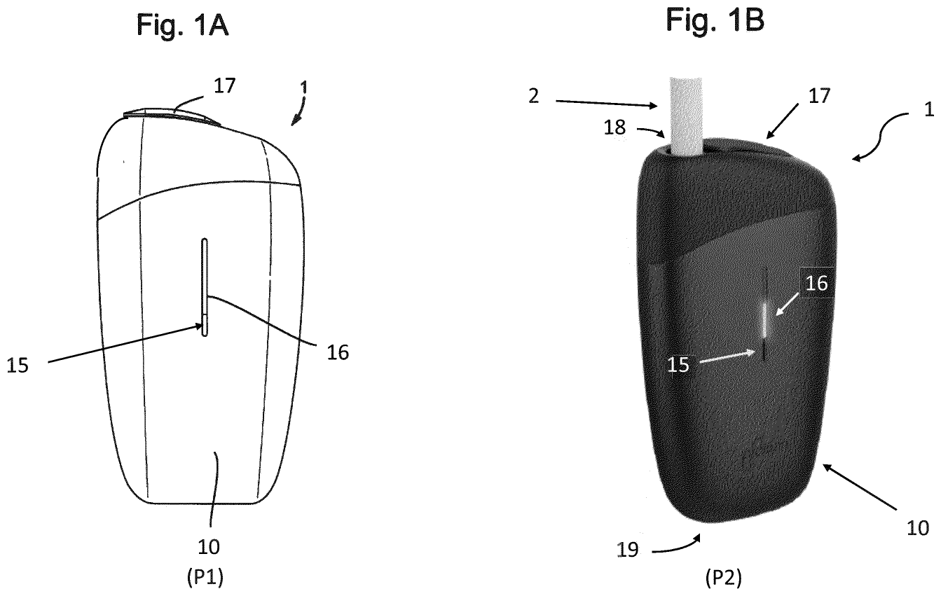

FIGS. 1A and 1B show perspective lateral views from an aerosol generation device 1 in two different operational modes, respectively; on the left, FIG. 1A shows the aerosol generation device 1 fitted with a slider 17 in a first, closed position P1 corresponding to a state in which it is switched off, whereas on the right, the aerosol generation device 1 is shown in a state where it has not only been switched on by putting the slider 17 in the second, open position P2, but also turned-on by pressing the lateral button 15 used as an active user interface to start the heating process of the aerosol substrate, referred to hereinafter as the tobacco stick 2, inserted in the opening 18.

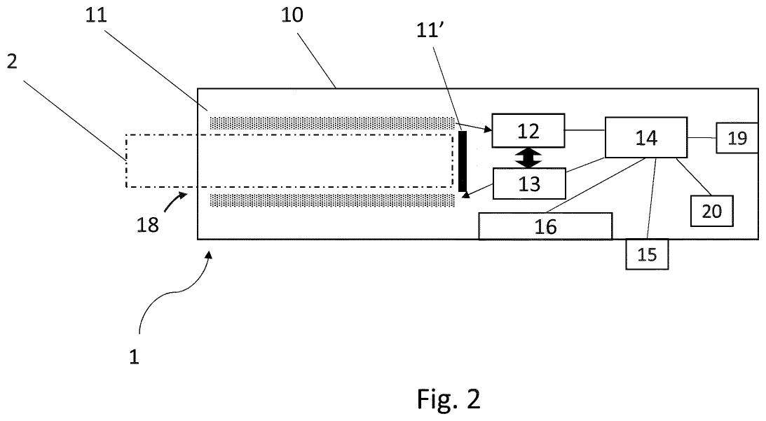

In FIG. 1A, it can be appreciated that the central LED display 16, provided in the middle of the housing 10 for intuitive user feedback, is off. In contrast, in FIG. 1B the LEDs show the status of the heat-up process, which is about half-way. According to a preferred embodiment, the starting of the heat-up phase is triggered by pressing the button 15 for about one second, and the heat-up progresses for about 20 seconds until reaching a ready-to-vape status for the stick 2, whereby the LEDs of the LED display 16 are fully lit and/or a vibration feedback is provided to the user. Then, the vaping time is controlled e.g. during a predetermined time, typically between 3 minutes and 40 second and 4 minutes and 10 seconds. During this time period, the temperature of the heating element 11 inside the housing 10 (not illustrated on these figures, but shown on the next FIG. 2) is controlled and the size of the LED bar lit on the display 16 is continuously reduced. Then, after this vaping time has lapsed, the heating element 11 is switched off also for a predetermined amount of time, typically 20 seconds, during which the remaining LEDs are blinking. After these final 20 seconds, the end of the vaping cycle is preferably acknowledged by a long vibration feedback, indicating that a sleep mode is reached again for the aerosol generation device and that a new vaping cycle may only be generated by pressing the button 15 again.

It can be appreciated on FIG. 1B that a charging connection 19 is foreseen for recharging the aerosol generation device 1, which can preferably be used for approximately be used for 20 tobacco sticks 2 when batteries are fully charged.

To summarize, the aerosol generation device 1 according to the preferred embodiment illustrated in FIGS. 1A & 1B comprises an opening 18 in which the tobacco stick 2 is to be inserted, whereby this opening can be covered by a slider 17, defining an operational status for the aerosol generation device 1 (switched-off in the first closed position P1, and switched-on in the second open position P2). Then, in the switched-on state, the aerosol generation device 1 can be turned on by pressing the button 15, preferably through a push & hold movement of about 1.5 second, which will result in a change from a so-called sleep mode to a so-called active mode, where the heating element can be activated and temperature control also becomes available. In the sleep mode, the LED display 16 can be used to show battery levels, while in the active mode, the LED bar shown by the LED display 16 can indicate the heating level and the vaping time available. The charging connection 19 preferably consists of a USB connection; connecting a cable when the aerosol generation device 1 is turned on would immediately result in a deactivation and switching back to the sleep mode again for charging, irrespective of whether this has been done during heat-up or vaping.

FIG. 2 shows a schematic logical view of an aerosol device according to the preferred embodiment illustrated in FIGS. 1A & 1B, wherein the aerosol substrate in the form of a tobacco stick 2 is inserted into the opening 18 arranged at the top extremity of the housing 10. For the sake of readiness of the figure, the slider 17 has been omitted, but it can be appreciated that the depicted aerosol generation device 1 is shown in the second position P2 of the slider 17, i.e. in which it is switched-on, and the housing 10 is inclined 90 degrees on the left with respect to the upright position.

The tobacco stick 2 is heated by a heating element 11 formed as a heating chamber or a heating tube, which is closed by a bottom plate 11′ not involved in the heating process but acting a stop for the tobacco sticks 2 inserted therein; air is drawn through the tobacco stick 2 and vapor is generated by the heat vaporizing of the constituents of the tobacco stick 2 and the vapor entrained during puffing. The temperature of the vapor is controlled by controlling the temperature of the heating element 11 by using a temperature sensor 12 such as e.g. a thermistor, and the vaporization is regulated by regulating the power supplied to the heating element 11 by using a heating controller 13 employing a PID control with temperature feedback. The heating controller can be implemented in form of an MCU.

The energy supply unit 14 is preferably a rechargeable power unit that can be connected to the sector through the charging connection 19, typically a USB plug. This energy supply unit 14 is connected to the temperature sensor 12 and the heating controller 13, and can be activated for starting a vaping session through a first active user interface, such as preferably a push button 15. Indeed, pressing the push button 15 down for a predetermined amount of time allows to turn the aerosol generation device 1 on and to pass from a sleep mode to an active mode where the heating element 11 is switched on. The energy supply unit 14 is also connected to a second passive user interface, preferably made of a LED display 16 indicating the battery level in the sleep mode, and the heating level or remaining vaping time in the active mode i.e. during a vaping cycle. This display is preferably combined with a vibrator 20 indicating key state change information to the user, such as when the aerosol generation device is just turned on, then when the stick 2 becomes ready to vape, and giving a warning later on when the vaping cycle is about to finish and eventually providing a final feedback when a vaping cycle has ended.

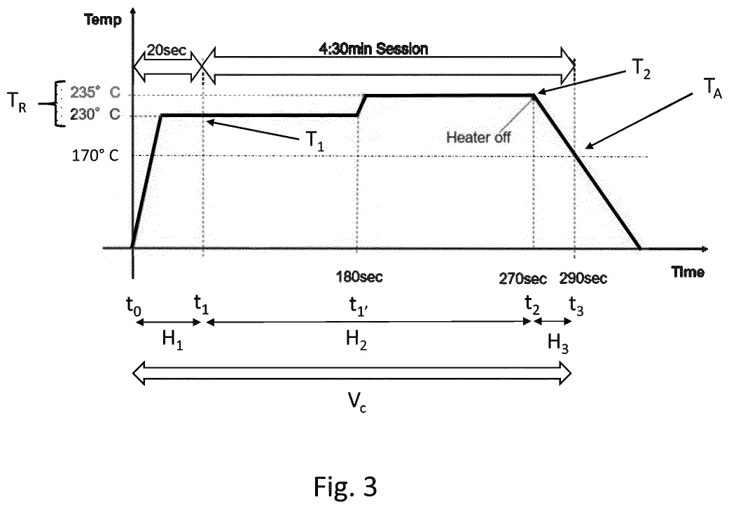

FIG. 3 shows the unfolding of a full vaping cycle V_{c} using an aerosol generation device 1 according to a preferred embodiment for the present invention, such as the device illustrated in the previous figures. The diagram of FIG. 3 represents the temperature of the heating element 11 with respect to the elapsed time during the vaping cycle V_{c} since the push button 15 has been pushed at activation time to until a vibrator feedback is received a time t₃, acknowledging the end of the vaping cycle V_{c}.

According to this preferred embodiment, when the user presses the push button 15, the aerosol generation device 1 is turned on and changes to an activated state. Therefore, this moment in time is referred to as activation time t₀, thereby indicating that a vaping cycle V_{c} has started, and that the heating element 11 may be switched on. This corresponds to the beginning of a first phase H₁, referred to as “heat-up” phase, during which the tobacco stick 2 is heated until it is considered as being ready to vape. Preferably, this first phase H₁ lasts for a predetermined amount of time, here for example 20 seconds, or may end sooner as soon as a first temperature T₁ is reached for the heating element, as it is the case in the graph of FIG. 3 where a flattening occurs before the 20 seconds have lapsed. However, this first temperature T₁ defined in order to reach a “ready to vape” status for the tobacco stick 2 is preferably always comprised within a predetermined temperature range T_{R}, here defined as between 230° C. and 235° C.

At the end of the first phase H₁, the ready to vape status is reached at time t₁, which can be indicated by the device by a predetermined LED signal and/or through a vibration feedback. Simultaneously a second phase H₂ is started, during which the heater is controlled by a temperature control scheme. The heating element 11 may then be powered on and off through PID control based on stored temperature profile and temperature measurement provided by the temperature sensor 12 sensing the temperature of the heating chamber forming the heating element 11. According to the preferred embodiment illustrated on FIG. 3, it can be appreciated that this temperature control scheme involves a slight re-heating at a middle time t₁ approximately halfway of the vaping cycle (here 180 seconds after t₁), arranged to reach the upper boundary of the temperature range T_{R} (235° C.) in order to compensate for the depletion of the substrate.

At the end of this second H₂ at time t₂, here 270 seconds after the start of the vaping at time t₁, the heating element 11 is switched off, and a third phase H₃, referred to as “heat-off” phase, is simultaneously started. This third phase H₃ starts while the temperature of the heater is still comprised within the operational temperature range T_{R}, but not necessarily equal to the first temperature T₁. Therefore, this other operational temperature for vaping is preferably referred to as the second temperature T₂, i.e. the one at the start of the heat-off phase (i.e. the third phase H₃).

This third heat-off phase H₃ preferably lasts for about 20 seconds; the start of this phase is preferably indicated by a dedicated display pattern in the display unit and/or also a vibration feedback, and the end of this phase at time t₃ marking the end of the full vaping cycle V_{c} is also preferably indicated by another vibration feedback—e.g. a long vibration in the end as compared to a short vibration at the start—and the LED display is preferably switched off at this end time t₃.

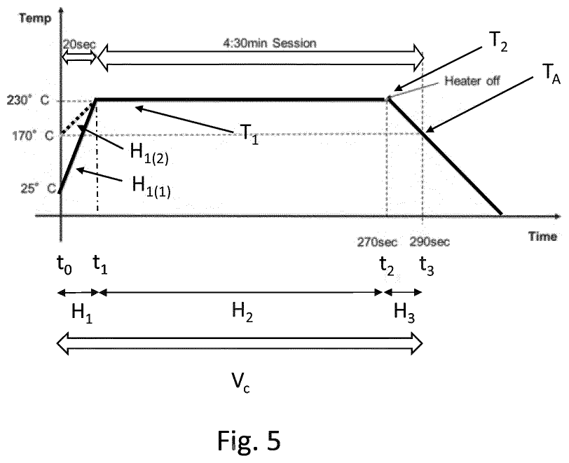

As it will be explained in the following, further in view of FIG. 5, the temperature control scheme according to this preferred embodiment for the present invention is preferably adjusted in order to reach a temperature at the end of a vaping cycle V_{c}, i.e. at time t₃, which is below the activation temperature T_{A}, this activation temperature T_{A} being itself well below the operational temperature range T_{R} of the heating element. This may allow to start a consecutive vaping cycle immediately after the previous one, while still ensuring a consistent user experience for the user at the time of the first puff. In the diagram of FIG. 3, this activation temperature T_{A} is for example set to be equal to 170° C.

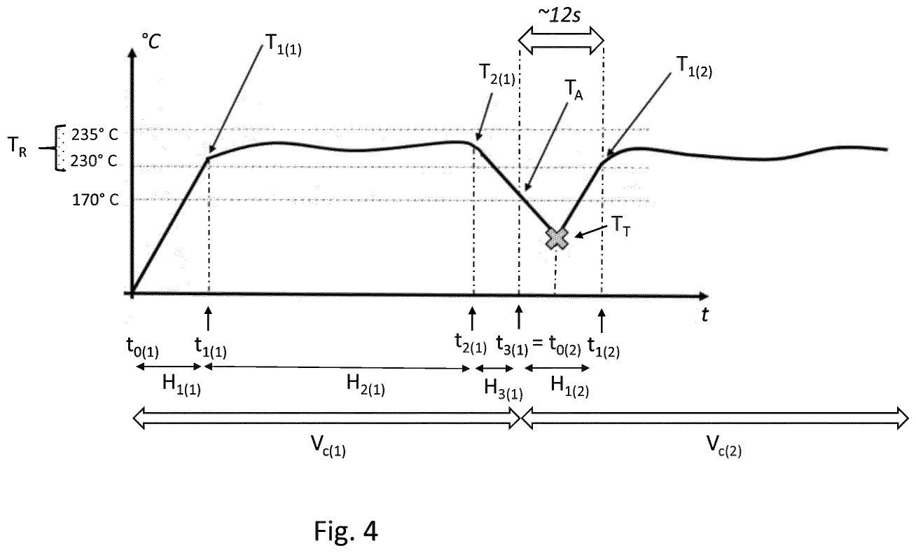

FIG. 4 shows a diagram representing the temperature of the heating element with respect to the elapsed time during two consecutive vaping cycles according to yet another preferred embodiment for the present invention, in which the heating element is allowed to cool further down after the push button 15 is actuated in order to start a consecutive vaping cycle. In other words, even if the start of a second vaping cycle V_{c(2)} is triggered right after the end of a first vaping cycle V_{c(1)}, the empowering of the heating element is delayed until a sufficiently low temperature, referred to as temperature threshold T_{T} is reached. The temperature threshold T_{T} is lower than the activation temperature T_{A} and therefore, in the case illustrated on FIG. 4, lower as 170° C.

In FIG. 4, it can be appreciated that all the references added as a suffix in parenthesis relate to a cycle number, i.e. t₀₍₁₎, t₁₍₁₎, t₂₍₁₎, t₃₍₁₎ merely correspond to the time values t₀, t₁, t₂, & t₃ of the generic vaping cycle V_{c}, yet applied to a first vaping cycle V_{c(1)}. Similarly the times t_{0(2) &} t₁₍₂₎ correspond to the values t_{0 &} t₁ applied to the second vaping cycle V_{c(2)} following immediately the first vaping cycle V_{c(1)}, since t₀₍₂₎=t₃₍₁₎. (i.e. the activation time of the second, consecutive vaping cycle V_{c(2)} is the same as the ending time of the first vaping cycle V_{c(1)}). The same applies also to the first temperatures reached after the first heat-up phases H₁₍₁₎ & H₁₍₂₎ of each vaping cycle, i.e. the temperature T₁₍₁₎ is first temperature of the first vaping cycle V_{c(1)}, while the temperature T₁₍₂₎ is first temperature of the second vaping cycle V_{c(2)}. However, only the second and third phases H₂₍₁₎ & H₃₍₁₎ of the first vaping cycle V_{c(1)} are represented. In this illustrated example, the temperature at the end of the first vaping cycle V_{c(1)} is also reached after a heat-off phase and is also set to correspond to a value at most equal to the activation temperature T_{A}, set to about 170° C. However, this heat-off phase is then extended and the heating element 11 cannot be switched on until the minimal temperature corresponding to the temperature threshold T_{T} is reached. Nevertheless, the heating element 11 is then automatically switched on until an operational vaping temperature is reached, such as the so-called first temperature T₁₍₂₎.

Assuming that the first heat-up phase of the first vaping cycle V_{c(1)} is still set to 20 seconds, it can be appreciated that the depicted graph shows that the ready-to-vape status reached at time t₁₍₂₎ for second vaping cycle V_{c(2)} comes sooner, after about 12 seconds. In other words, the heat-up phase of the second vaping cycle V_{c(2)} may be shorter than the one of the first vaping cycle. This embodiment corresponds to an option where a variable time is allowed to reach the ready-to-vape status, which will most likely be shorter for any consecutive vaping cycles started at a temperature significantly higher than the first one started at room temperature. Such shorter heat-up phases are aimed at compensating the higher energy provided otherwise to the stick during a consecutive vaping cycle started at higher temperature, so that the difference for the user at the time of the first puff is minimized. It can be appreciated though that despite the fact that power feeding to the heating element 11 is first delayed, the overall latency between consecutive vaping cycles, i.e. between the time when a cycle is completed until the time when a next stick is ready to vape, is minimized, and in any case shorter than the time lapsed before a first stick is ready to vape.

However, according to a variant embodiment, the same heat-up time, i.e. the time period lapsed between the activation time and the ready-to-vape time, is kept constant irrespective of the vaping cycle. In the present case, this would mean, keeping e.g. the time of the heat-up phase constant, and equal to 20 seconds, irrespective of the temperature at activation time of the vaping cycle. This should, however, preferably be combined with a finer control of the temperature in order to further adjust the energy supplied to the stick during this heating-up phase and over a constant period of time in order to not exceed any supplied energy level leading to a significant difference for the user at the time set for the first puff (i.e. at time t₁).

FIG. 5 shows an example of an alternative embodiment for the present invention according to which there is no extended heat-off phase after the end of a vaping cycle V_{c}, and where the first heat-up phases are fixed, kept to 20 seconds. In order to simplify the visualization of the difference between the first vaping cycle and any consecutive vaping cycles, a generic vaping cycle V_{c} similar as in FIG. 3 is shown, with the same time values t₀, t₁, t₂, & t₃ and duration of the various phases (first phase H₁ of heating up, second phase H₂ of vaping control, and third phase H₃ of heating-off). The difference between the vaping cycle V_{c} of FIG. 3 and FIG. 5 is that the first temperature T₁ reached at the time t₁ of the first puff is the same as the second temperature T₂ at the end of the second phase H₂ when the heating element 11 is switched off, i.e. 230° C. However, according to a variant embodiment, in order to ensure that a temperature value below the activation temperature T_{A} is always reached at the end of the vaping cycle V_{c}, timers for the duration of the third heat-off phase H₃ may be adjusted depending on the exact temperature of the heating element 11 within the operational temperature range T_{R} at the time when the heating element is switched off. Irrespective of whether the duration of this third heat-off phase H₃ is fixed or variable, the overall time period during which the heating element 11 cools down is supposed to be adjusted in order to be long enough to enable to reach a temperature value below the activation temperature T_{A}. This activation temperature T_{A} is also set to 170° C. according to the embodiment illustrated on FIG. 5; however, in order to compensate the fact that no further cooling down is foreseen at the beginning of a new vaping cycle V_{c} as opposed to the previous embodiment illustrated on FIG. 4, the activation temperature T_{A} could thus preferably be set to 160° C. or even lower (e.g. 150°).

FIG. 5 highlights the only difference between the first vaping cycle and any consecutive cycle by superimposing the first phase of the first cycle, labeled as H₁₍₁₎ when starting at room temperature, with the first phase of the second cycle, labeled as H₁₍₂₎, when starting directly at activation temperature T_{A}, the latter being depicted as a dotted line. Both heat-up phases having the same duration, no further delay is introduced between vaping cycles and therefore changing of stick is as straightforward as inserting a first one into the aerosol generation device 1. However, according to such an embodiment, the energy level provided to the stick during the first phase of heating up the first vaping cycle H₁₍₁₎ will be lower than the one provided to the stick during the first phase of the second vaping cycle H₁₍₂₎ and of any subsequent vaping cycles, i.e. of any consecutive cycles. As a result, according to a preferred variant embodiment for the invention, even if no delay is required before feeding power to the heating element in order to reach a lower temperature threshold T_{T} than a pre-set activation temperature T_{A}, it would then be advantageous to generate a low power mode upon activation of the heating element 11 (i.e. at activation time to at the start of a vaping cycle) in order to further minimize the difference of energy supplied to the stick until the heating element 11 reaches the first temperature T₁, potentially corresponding to the time of the first puff for the user. Most preferably, the temperature control scheme should be adjusted such that the level of energy supplied to the stick should remain within a predetermined range irrespective of the temperature of said heating element at activation time to of any vaping cycle V_{c}.

The embodiments detailed in the description above are given by way of example only and should not be understood as limitative for the conferred scope of protection. In particular, although the preferred embodiments define an operational temperature T_{R} as being comprised within preferably 230° and 235°, this range could be broader than this or shifted according to the needs and the components of the aerosol substrate (i.e. the stick). The same applies to the activation temperature T_{A}.

Also, the beginning of the third period H₃ of “heating off” could be triggered either by different elapsed times or by puff counts and may also last somewhat longer in order to give the users some more time to prepare most efficiently for the replacement of the stick in a seamless manner.

A common feature to all embodiments though, is that power shall be prevented from being supplied to the heating element 11 at activation time t₀, i.e. whenever a user requests the start of a vaping cycle Vc, by pressing a push button 15 or interacting with any other suitable user interface, as long as the temperature of the heating element 11 is above the predetermined activation temperature T_{A} threshold. This way, efficient prohibition of the heating mechanism of the aerosol substrate 2 is provided above this temperature threshold, and hence most consistent vaping experience is ensured, irrespective of the initial temperature conditions within the aerosol device.

It will also be understood that heat-not-burn devices such as the claimed aerosol generation device may heat other forms of substrates than sticks according to the needs without departing from the scope of the present invention.

### REFERENCES LIST

| | |
|---|---|
| 1 | Aerosol device |
| 10 | Housing |
| 11 | (Vapor) heating element (e.g. tube) |
| 11′ | Bottom plate |
| 12 | Temperature sensor |
| 13 | Heating Controller (e.g. PID) |
| 14 | Energy supply |
| 15 | Push button (first user interface) |
| 16 | LED display (second user interface) |
| 17 | Slider |
| 18 | Opening |
| 19 | Charging connection |
| 20 | Vibrator |
| 2 | Tobacco stick [by way of example for the aerosol substrate] |
| V_{c} | Vaping cycle |
| V_{c(1)} | First vaping cycle |
| V_{c(2)} | Second vaping cycle [or any consecutive V_{C}] |
| P₁ | “Off” position of slider |
| P₂ | “On” position of slider |
| H₁ | First phase - heat-up |
| H₂ | Second phase - vaping control |
| H₃ | Third phase - heat-off |
| T_{A} | Activation temperature [T_{A} < T_{R}] |
| T₁ | First temperature used for reaching the “ready to vape” status |
| T₂ | Temperature of the heater when turned off |
| T_{R} | Ready to vape temperature range |
| T_{T} | Temperature threshold |
| t₀ | Activation time/start of first phase H1 |
| t₁ | End of first phase H1/start of second phase H2 |
| t_{1′} | Time of mid vaping phase/re-heating |
| t₂ | End of second phase H2/start of third phase H3 |
| t₃ | End of third phase H3 |

1. An aerosol generation device comprising:
a heating element arranged for heating an aerosol substrate;
an energy supply configured to power said heating element;
a temperature sensor configured to measure temperature of said heating element;
a controller configured to control, as soon as said aerosol generation device is turned on, power supplied from said energy supply to the heating element to heat up the heating element to a first temperature within an operational temperature range,
wherein the power can only be supplied to said heating element at an activation time, when said aerosol generation device is turned on, if the temperature of said heating element is lower than a predetermined activation temperature.

2. The aerosol generation device according to claim 1, wherein said activation time is when said aerosol device is turned on upon user's request in order to start a vaping cycle, and wherein the power is prevented from being supplied to said heating element, at said activation time, as long as the temperature of said heating element is above said predetermined activation temperature threshold.

3. The aerosol generation device according to claim 1, wherein said aerosol substrate is a tobacco stick.

4. The aerosol generation device according to claim 1, wherein a temperature control scheme of said controller is adjusted so that the temperature of said heating element at the end of a vaping cycle is below said predetermined activation temperature.

5. The aerosol generation device according to claim 4, wherein said vaping cycle includes a final heat-off phase during which power is switched off to said heating element for a predetermined time period.

6. The aerosol generation device according to claim 1, wherein said predetermined activation temperature is set to be at most equal to approximately 170° C.

7. The aerosol generation device according to claim 1, wherein said controller is configured to further delay power supply to said heating element, after said activation time until another predetermined temperature threshold, set below said activation temperature, is reached by said heating element.

8. The aerosol generation device according to claim 1, wherein said controller is configured to generate a low power supply mode at said activation time when said aerosol device is turned on, if a temperature below said activation temperature is detected for said heating element.

9. The aerosol generation device according to claim 1, further comprising an active user interface for receiving user input to turn said aerosol generation device on.

10. The aerosol generation device according to claim 9 wherein said active user interface is a push button.

11. The aerosol generation device according to claim 1, further comprising a passive user interface arranged for providing indication on mode or status of said aerosol generation device.

12. The aerosol generation device according to claim 11, wherein said passive user interface is configured as a central LED display.

13. The aerosol generation device according to claim 1, further comprising a vibrator arranged to provide feedback on state transitions of said aerosol generation device.

14. The aerosol generation device according to claim 1, further comprising a slider arranged to cover said heating element in a first position, and to leave space for insertion of said aerosol substrate in a second position, wherein said aerosol generation device can only be turned on when said slider is in said second position.

15. The aerosol generation device according to claim 1, wherein said power is supplied to said heating element until said heating element reaches said first temperature so that an amount of energy provided to the aerosol substrate remains within a predetermined range irrespective of the temperature of said heating element at the activation time.
